(19) United States
(12) Patent Application Publication
(10) Pub. No.: US 2025/0112405 A1
(43) Pub. Date: Apr. 3, 2025

(54) CONNECTOR

(71) Applicant: SUMITOMO WIRING SYSTEMS, LTD., Mie (JP)

(72) Inventors: Ryuta TAKAHASHI, Mie (JP); Yukihiro FUKATSU, Mie (JP); Yuuichi IZAWA, Mie (JP)

(21) Appl. No.: 18/897,567

(22) Filed: Sep. 26, 2024

(30) Foreign Application Priority Data
Sep. 28, 2023 (JP) 2023-166668

(51) Int. Cl. H01R 13/633; H01R 4/34; H01R 13/04

(52) U.S. Cl. CPC H01R 13/633; H01R 4/34; H01R 13/04

(57) ABSTRACT

A connector includes a conductive member that can achieve both strength and ease of dismantlement. The conductive member 40 includes: a fastening portion 42 located outside a housing 20 and fastened to a fixing portion 30; a connecting portion 43 located inside the housing 20 and connected to a terminal 90; and joining portions 44 and 45 located between the connecting portion 43 and the fastening portion 42, outside the housing 20. The joining portions 44 and 45 include: a weak portion 44 integrally joined to each of the connecting portion 43 and the fastening portion 42 and breakable; and a reinforcing portion 45 extending at least from one side to another side out of a side where the connecting portion 43 is located and a side where the fastening portion 42 is located, and locked on the other side.

### CROSS-REFERENCE TO RELATED APPLICATIONS

This application is based on and claims priority from Japanese Patent Application No. 2023-166668, filed on Sep. 28, 2023, with the Japan Patent Office, the disclosure of which is incorporated herein in its entirety by reference.

### TECHNICAL FIELD

The present disclosure relates to connectors.

### BACKGROUND

The connector disclosed in JP 2013-073925 A includes a housing and a metal conductive member attached to the housing. The conductive member includes a connecting portion connected to female terminals that are connected to electric wires, and a ground connecting portion led out of the housing and fixed to a vehicle. The conductive member has a groove in a part located inside the housing. When dismantling the vehicle, the electric wires drawn out of the housing are pulled by a crane or the like while the ground connecting portion is fixed to the vehicle. As a result, the groove is broken (destroyed), and the part of the conductive member closer to the ground connecting portion than the groove remains on the vehicle whereas the part of the conductive member closer to the connecting portion than the groove is pulled away from the vehicle together with the electric wires.

In the connector disclosed in JP 2013-073925 A, the groove is located inside the housing. Accordingly, a relatively small force such as vibration acting on the vehicle other than when dismantling the vehicle is received by the housing and is not directly transmitted to the groove. The groove can thus be prevented from breaking due to such a relatively small force.

The technique of removing electric wires, etc. from a vehicle is also disclosed in JP 2003-203687 A. The conductive member in JP 2013-073925 A is a terminal called a ground joint terminal. Such ground joint terminals are also disclosed in JP 2011-103192 A and JP 2022-113255 A.

### SUMMARY

Unlike the connector in JP 2013-073925 A, in some cases the design circumstances of connectors make it necessary to adopt a structure in which a groove is located outside the housing. If a weak portion such as a groove is located outside the housing, a relatively small force such as vibration acting on the vehicle may break the weak portion unintentionally. This requires some kind of measure.

The present disclosure therefore has an object of providing a connector including a conductive member that can achieve both strength and ease of dismantlement.

A connector according to the present disclosure includes: a housing; and a conductive member made of metal and attached to the housing, wherein the conductive member includes: a fastening portion located outside the housing and fastened to a fixing portion; a connecting portion located inside the housing and connected to a terminal; and a joining portion located between the connecting portion and the fastening portion, outside the housing, and the joining portion includes: a weak portion integrally joined to each of the connecting portion and the fastening portion and breakable; and a reinforcing portion extending at least from one side to another side out of a side where the connecting portion is located and a side where the fastening portion is located, and locked on the other side.

According to the present disclosure, it is possible to provide a connector including a conductive member that can achieve both strength and ease of dismantlement.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector according to Embodiment 1 of the present disclosure as seen obliquely from above and behind.

FIG. 2 is a side sectional view of the connector.

FIG. 3 is a plan view of the rear part of the connector.

FIG. 4 is a perspective view of a housing body as seen obliquely from above and front.

FIG. 5 is a perspective view of the housing body as seen obliquely from above and behind.

FIG. 6 is a perspective view of a conductive member as seen obliquely from below and front.

FIG. 7 is a perspective view of the conductive member as seen obliquely from above and behind.

FIG. 8 is an enlarged perspective view showing a state of locking between a first locking portion and a first locked portion.

FIG. 9 is an enlarged perspective view showing a state of locking between a second locking portion and a second locked portion.

FIG. 10 is an enlarged sectional view showing a state in which a tip portion of an extending portion in the extending direction is fitted in a receiving portion.

FIG. 11 is a perspective view of the part of the conductive member that remains on the vehicle after dismantlement of the vehicle, as seen obliquely from above and behind.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, embodiments of the present disclosure will be listed and described below.
(1) A connector according to the present disclosure includes: a housing; and a conductive member made of metal and attached to the housing, wherein the conductive member includes: a fastening portion located outside the housing and fastened to a fixing portion; a connecting portion located inside the housing and connected to a terminal; and a joining portion located between the connecting portion and the fastening portion, outside the housing, and the joining portion includes: a weak portion integrally joined to each of the connecting portion and the fastening portion and breakable; and a reinforcing portion extending at least from one side to another side out of a side where the connecting portion is located and a side where the fastening portion is located, and locked on the other side.

When a relatively large force acts on the conductive member, for example, during dismantlement of a vehicle having the connector mounted thereon, the lock between the reinforcing portion and the other side (the side on which the reinforcing portion is locked) is released and the weak portion is broken (destroyed). As a result, the part of the conductive member on the fastening portion side (i.e. the side where the fastening portion is located) remains on the fixing portion side and the part of the conductive member on the connecting portion side (i.e. the side where the connecting portion is located) is pulled away from the fixing portion side.

When a relatively small force acts on the conductive member, for example, during mounting of the connector onto the vehicle or while the vehicle is running, the force is distributed to not only the weak portion but also the reinforcing portion, so that the weak portion can be prevented from breaking unintentionally.
(2) Preferably, in the connector according to (1), the connecting portion is located forward of and above the fastening portion, and the reinforcing portion extends rearward and downward from the connecting portion and has a lower end locked by the fastening portion, and includes a cover portion covering the weak portion from behind.

Since the weak portion is protected by being covered with the cover portion from behind, the weak portion can be prevented from being broken or damaged by an external force. Moreover, since the reinforcing portion extends rearward and downward from the connecting portion, the reinforcing portion is also pulled away from the fixing portion side when, for example, the vehicle is dismantled, with it being possible to reduce the amount of the conductive member remaining on the fixing portion. Hence, the conductive member can be collected efficiently.
(3) Preferably, in the connector according to (2), the fastening portion includes a first locking portion that faces the reinforcing portion from front and a second locking portion that faces the reinforcing portion from above.

For example, when such a force that pulls the connecting portion forward acts on the conductive member, the first locking portion locks the reinforcing portion rearward, so that the lock between the reinforcing portion and the fastening portion can be maintained. When such a force that pulls the connecting portion upward acts on the conductive member, the second locking portion locks the reinforcing portion, so that the lock between the reinforcing portion and the fastening portion can be maintained. Thus, the lock between the reinforcing portion and the fastening portion can be maintained regardless of whether a force acts on the conductive member in the forward or upward direction.
(4) Preferably, in the connector according to (2) or (3), the connecting portion includes: an upper busbar portion; a lower busbar portion located below the upper busbar portion; and a joint portion joining the upper busbar portion and the lower busbar portion at one end, the upper busbar portion and the lower busbar portion each include a plurality of tabs protruding forward, the weak portion extends rearward and downward from the lower busbar portion, and the reinforcing portion extends rearward and downward from the upper busbar portion.

Since the weak portion extends from the lower busbar portion and the reinforcing portion extends from the upper busbar portion, the connecting portion, the weak portion, the reinforcing portion, and the fastening portion can be produced from conductive plate material with good yield.
(5) Preferably, in the connector according to any one of (1) to (4), the reinforcing portion is shaped to extend from the one side to the other side, and the weak portion is shaped to extend from the one side to the other side in a detour so as to be longer than the reinforcing portion.

When a relatively large force acts on the conductive member, for example, during dismantlement of the vehicle, first the lock between the reinforcing portion and the other side is released and then the weak portion is destroyed. It is thus possible to appropriately achieve each of the state in which the lock between the reinforcing portion and the other side is released and the state in which the weak portion is destroyed. In addition, the load (stress) acting on the conductive member can be distributed in the length direction of the weak portion because the weak portion extends in a detour.
(6) Preferably, in the connector according to any one of (1) to (5), the conductive member includes an extending portion extending from the fastening portion toward the connecting portion, the extending portion is located away from the joining portion, and the housing includes a receiving portion in which a tip portion of the extending portion in an extending direction is fitted.

For example, when a bending force (bending load) acts on the joining portion, the fitted part of the extending portion and the receiving portion can resist the bending load. Since the extending portion is located away from the joining portion, the bending load transmitted to the locked part of the reinforcing portion and the other side can be reduced and the lock between the reinforcing portion and the other side can be maintained. In addition, since the extending portion does not have a structure of being locked in the housing, the extending portion can easily come out of the housing when a relatively large force acts on the conductive member during, for example, dismantlement of the vehicle.
(7) Preferably, in the connector according to (6), a rear surface of the housing is a drawing surface from which the conductive member is drawn out, and the receiving portion is a lightening hole that opens on the drawing surface.

The receiving portion has both the function of receiving the extending portion and the function of a lightening hole (such as preventing shrinkage of the housing and reducing the weight). Hence, the formation of the receiving portion does not complicate the structure of the housing.

### Details of Embodiments of the Present Disclosure

Specific examples according to the present disclosure will be described below, with reference to the drawings. The present disclosure is not limited to these examples, but is defined by the claims and intended to include all modifications within the meaning and scope equivalent to the claims.

### Embodiment 1

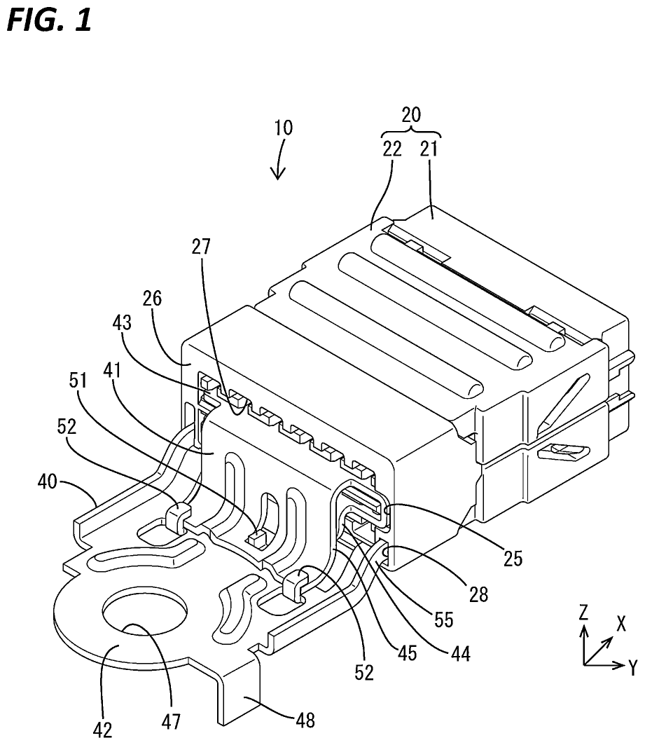

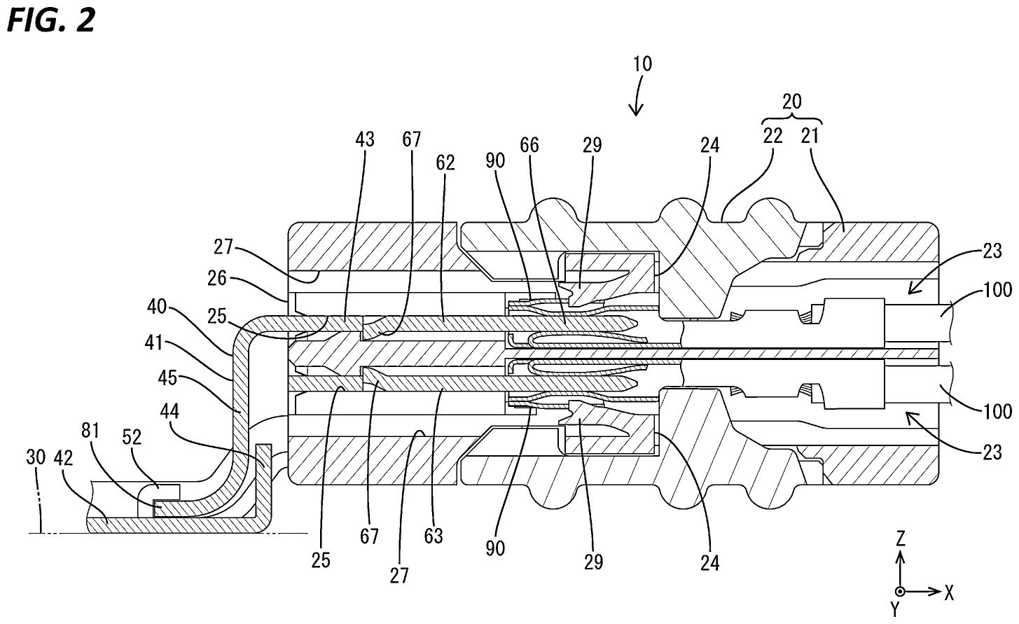

A connector 10 according to Embodiment 1 includes a housing 20, a conductive member 40 attached to the housing 20, and a plurality of terminals 90 contained in the housing 20, as shown in FIG. 2. Each terminal 90 is connected (jointed) to the conductive member 40 inside the housing 20. In the following description, the side where each terminal 90 is located relative to the conductive member 40 is referred to as the front side in the front-rear direction. The up-down direction (vertical direction) is based on the up-down direction in FIG. 2. Symbols X, Y, and Z in FIGS. 1 and 2 respectively represent forward, leftward (leftward when seen from the front), and upward. These directions are set for the sake of convenience, and do not necessarily coincide with the directions in a state in which the connector 10 is mounted on a vehicle (not shown) or the like.

### (Terminal 90)

Each terminal 90 is integrally formed by, for example, bending a conductive metal plate. As shown in FIG. 2, the rear end of the terminal 90 is connected by crimping to the terminal portion of a coated electric wire 100. The front end of the terminal 90 is tubular, and allows the below-described tab 66 of the conductive member 40 to be connectably inserted therein.

### (Housing 20)

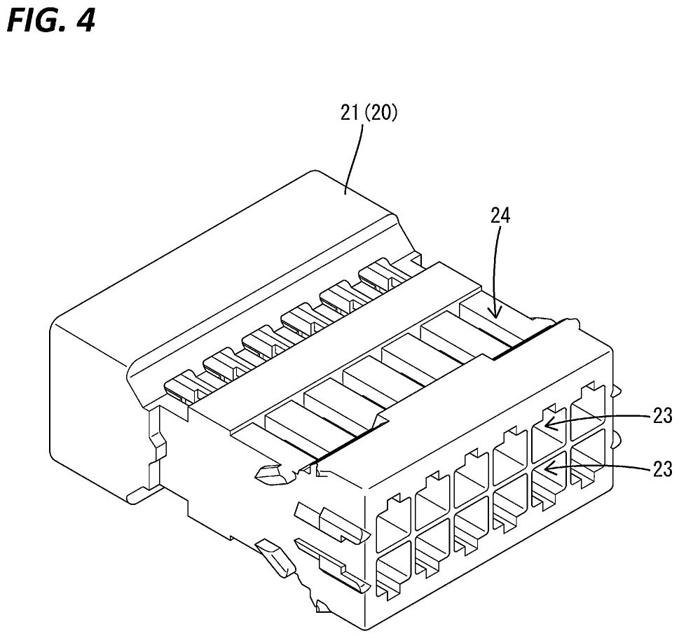

The housing 20 is made of synthetic resin. As shown in FIG. 2, the housing 20 includes a housing body 21 and a retainer 22 that is movably installed on the housing body 21. As shown in FIGS. 2 and 4, a plurality of cavities 23 capable of containing the respective terminals 90 are formed in the front part of the housing body 21. The cavities 23 are arranged in two rows, i.e. upper and lower rows, and open on the front surface of the housing body 21. The coated electric wires 100 connected to the terminals 90 extend forward from the housing body 21.

As shown in FIG. 2, a pair of upper and lower retainer insertion holes 24 are formed in an intermediate part of the housing body 21 in the front-rear direction. The pair of retainer insertion holes 24 open on the upper and lower surfaces of the housing body 21. The rear end of each cavity 23 communicates with the corresponding retainer insertion hole 24. The retainer 22 is inserted and attached in each retainer insertion hole 24.

The housing body 21 includes an elastically deformable lance 29 that protrudes into each cavity 23. The terminal 90 is inserted into the cavity 23 from the front of the housing body 21, and is locked by the lance 29 to be primarily restricted from coming out of the cavity 23. The terminal 90 is also secondarily restricted from coming out of the cavity 23 by the retainer 22 inserted into the retainer insertion hole 24.

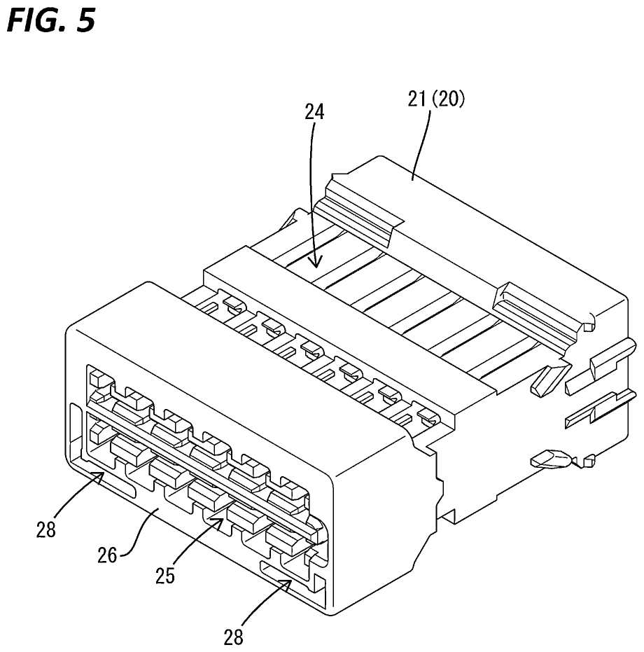

As shown in FIGS. 2 and 5, an attachment hole 25 into which the conductive member 40 can be attached is formed in the rear part of the housing body 21. The attachment hole 25 has a slit-like cross-sectional shape corresponding to the conductive member 40 (described later), and opens on the rear surface of the housing body 21. The rear surface of the housing body 21 is a drawing surface 26 from which an exposed portion 41 of the conductive member 40 is drawn out. As shown in FIGS. 1 and 2, the conductive member 40 includes the exposed portion 41 that extends rearward and downward from the drawing surface 26. A die removal hole 27 formed as a result of removing a die (not shown) for forming the lance 29 opens on the drawing surface 26 at a position adjacent to the attachment hole 25.

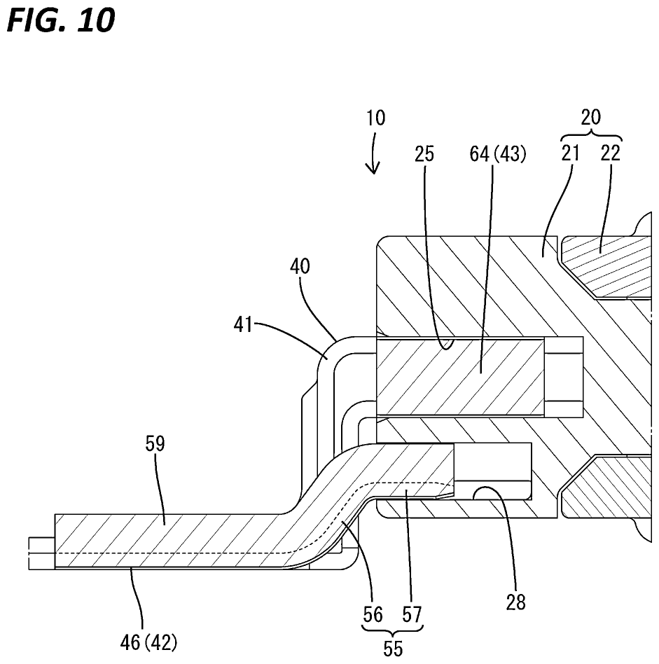

The housing body 21 includes a pair of receiving portions 28 that open at the left and right ends of the lower side of the drawing surface 26, around the attachment hole 25. As shown in FIG. 10, each receiving portion 28 extends in the front-rear direction inside the housing body 21 and receives the below-described extending portion 55 of the conductive member 40 from behind in a fitted state. As shown in FIG. 5, each receiving portion 28 is L-shaped in rear view, and is composed of a part extending in the left-right direction and a part extending upward from the outer end of the part extending in the left-right direction. The part of each receiving portion 28 receiving the extending portion 55 (excluding the inner end in the left-right direction) opens at a position that does not overlap with the exposed portion 41 of the conductive member 40 in rear view of the connector 10 (see FIG. 1).

### (Conductive Member 40)

The conductive member 40 is integrally formed by, for example, bending a conductive metal plate. As shown in FIG. 2, the conductive member 40 includes a fastening portion 42, a connecting portion 43 located inside the housing body 21, and joining portions 44 and 45 located between and joining the connecting portion 43 and the fastening portion 42. The exposed portion 41 located outside the housing 20 is composed of the fastening portion 42 and the joining portions 44 and 45. As shown in FIGS. 2, 3, and 10, the connecting portion 43 is inserted into the attachment hole 25 and located inside the housing 20.

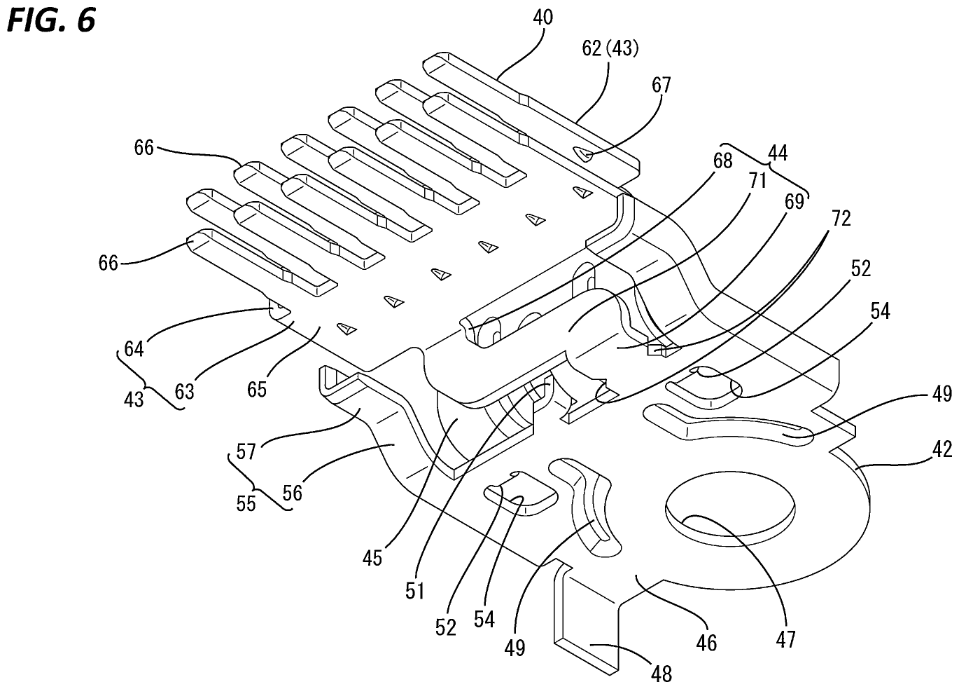

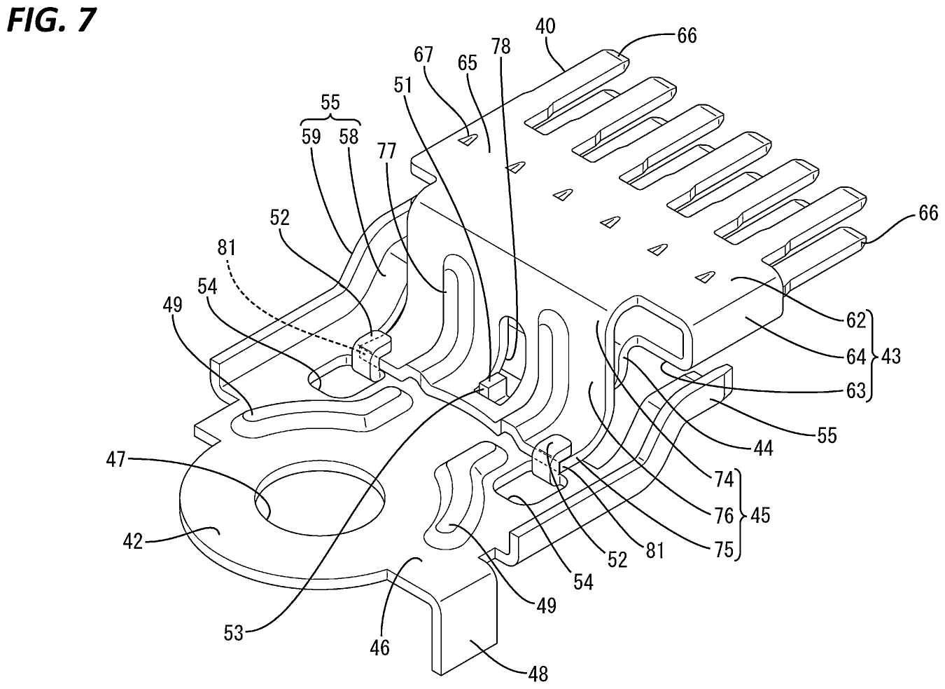

As shown in FIGS. 6 and 7, the fastening portion 42 includes a fastening body 46 with plate surfaces facing up and down. A circular fastening hole 47 is formed through the fastening body 46 in the plate thickness direction (up-down direction). The conductive member 40 is screwed to a fixing portion 30 (see FIG. 2) in a grounded state via a fixing member such as a bolt (not shown) inserted into the fastening hole 47. The fastening portion 42 includes a rotation preventive portion 48 that bends and extends downward from one of the left and right ends. The rotation preventive portion 48 is rectangular in side view with plate surfaces facing left and right. The rotation preventive portion 48 is fitted into, for example, a hole (not shown) of the fixing portion 30 to prevent rotation of the conductive member 40 and position the conductive member 40 relative to the fixing portion 30.

As shown in FIGS. 6 and 7, the fastening body 46 has embossed fastening side ribs 49 bulging upward. In detail, a pair of fastening side ribs 49 are arranged near the left and right ends of the fastening body 46. Each fastening side rib 49 is composed of a part extending with curvature around the fastening hole 47 and a part extending forward from the front end of the part extending with curvature.

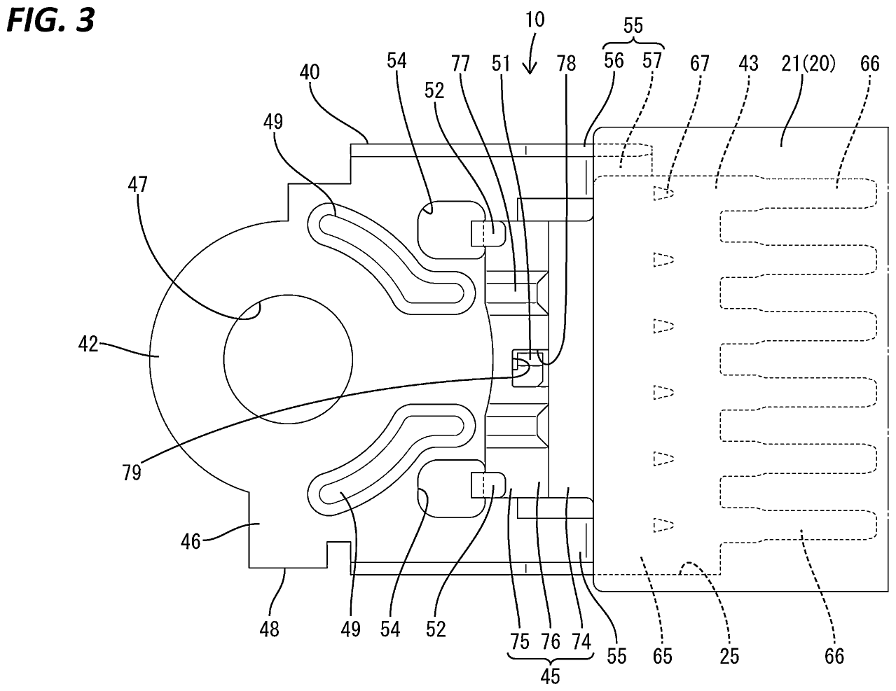

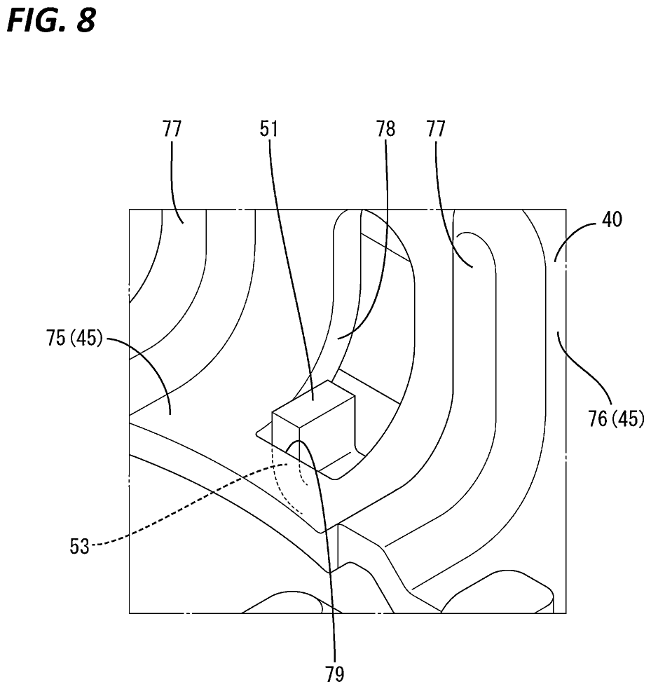

As shown in FIGS. 3, 6, and 7, the fastening portion 42 includes a first locking portion 51 and second locking portions 52. The first locking portion 51 bends upward to stand from an intermediate part in the left-right direction (i.e. a part excluding the left and right ends) of the front end of the fastening body 46. As shown in FIG. 8, the first locking portion 51 is rectangular in side view with plate surfaces facing left and right. The rear end surface (plate thickness surface) of the first locking portion 51 is a first locking surface 53 capable of locking the below-described first locked portion 78.

As shown in FIGS. 3 and 7, a pair of second locking portions 52 are arranged near the front end of the fastening body 46 at positions close to the left and right sides. Each second locking portion 52 is formed by cutting and raising part of the fastening body 46. The fastening body 46 has a hole 54 adjacent to each second locking portion 52, resulting from cutting and raising part of the fastening body 46 to form the second locking portion 52.

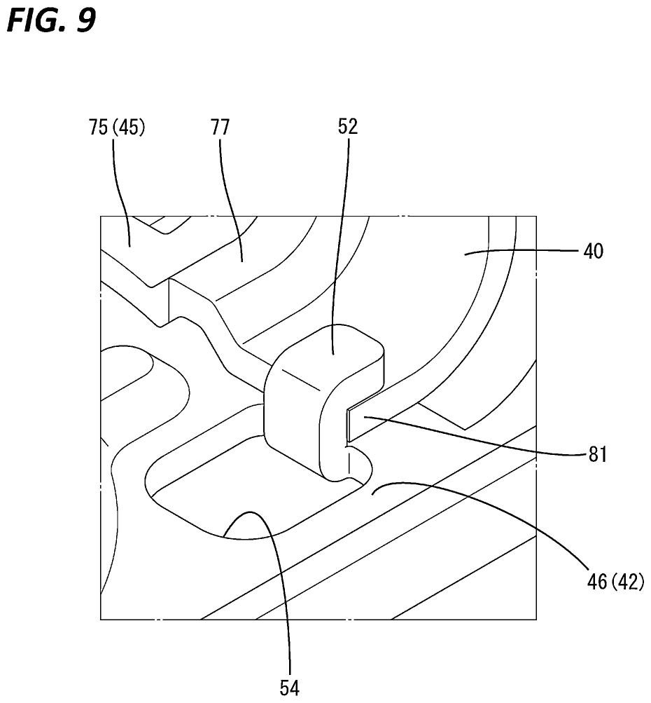

Each second locking portion 52 is folded forward so as to sandwich the below-described second locked portion 81. As shown in FIGS. 2 and 9, the second locked portion 81 is sandwiched between the fastening body 46 and the second locking portion 52 from above and below, and faces and contacts each of the upper surface of the fastening body 46 and the lower surface of the second locking portion 52. The part of the second locking portion 52 protruding upward from the fastening body 46 faces and contacts the rear end surface (plate thickness surface) of the second locked portion 81.

As shown in FIGS. 3 and 7, the conductive member 40 includes a pair of extending portions 55 that extend forward from the left and right ends of the front end of the fastening body 46. The extending portions 55 extend forward from both ends of the fastening body 46 independently, and are each located away from the joining portions 44 and 45 on the outer side in the left-right direction. As shown in FIGS. 3, 6, 10, and 11, each extending portion 55 includes an inclined portion 56 inclined upward in the forward direction from the fastening portion 42 side and a tip portion 57 extending straight forward from the front end of the inclined portion 56, as seen in the extending direction. The tip portion 57 is located forward of and above the fastening body 46. As shown in FIG. 10, the tip portion 57 is located below the connecting portion 43 so as to overlap the connecting portion 43 in the front-rear direction.

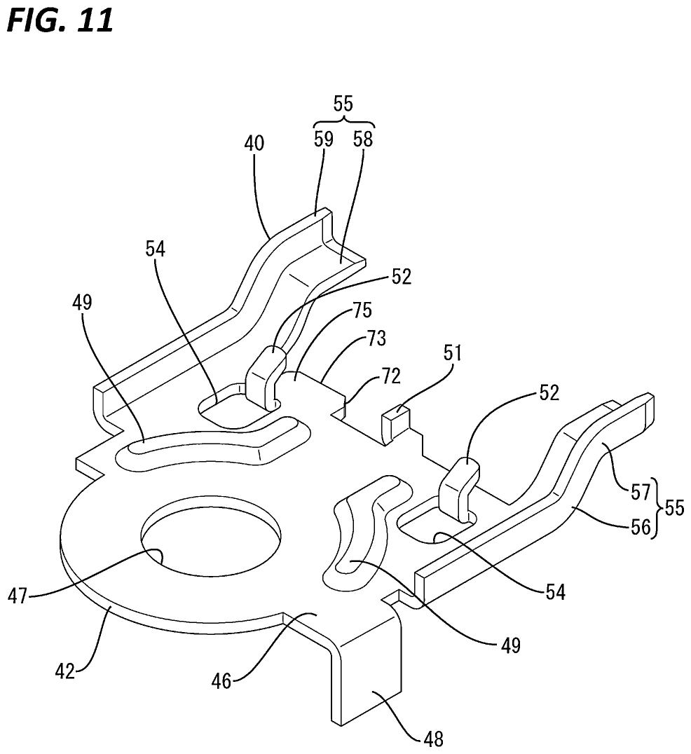

The cross-section of each extending portion 55 (i.e. section cut in a direction orthogonal to the extending direction of the extending portion 55) is L-shaped, as with the cross-section of each receiving portion 28. As shown in FIGS. 7 and 11, each extending portion 55 includes an extension body (horizontal plate portion 58) that is continuous with the fastening body 46 and has plate surfaces facing up and down and an extension rib (vertical plate portion 59) that rises from the outer end of the horizontal plate portion 58 in the left-right direction and has plate surfaces facing left and right, as seen in the left-right direction. The vertical plate portion 59 is also continuously formed on the outer end of the fastening body 46 in the left-right direction.

As shown in FIGS. 6 and 7, the connecting portion 43 includes an upper busbar portion 62 having plate surfaces facing up and down, a lower busbar portion 63 located below the upper busbar portion 62 and having plate surfaces facing up and down, and a joint portion 64 joining the lower busbar portion 63 and the upper busbar portion 62 at one end in the left-right direction (the right end in the drawings).

The upper busbar portion 62 and the lower busbar portion 63 each include a band plate-shaped busbar body 65 extending in the left-right direction, and a plurality of tabs 66 protruding forward from the front end of the busbar body 65. The tabs 66 are arranged side by side at regular intervals in the left-right direction at the front end of the busbar body 65 so as to have the same pitch in the upper busbar portion 62 and the lower busbar portion 63. Moreover, the upper busbar portion 62 and the lower busbar portion 63 each have a plurality of cut-out projections 67. The cut-out projections 67 are arranged side by side at intervals in the left-right direction on the busbar body 65 so as to correspond to the tabs 66 individually. As shown in FIG. 2, in a state in which the connecting portion 43 is inserted in the attachment hole 25, the cut-out projections 67 are locked by the inner surface of the attachment hole 25. Thus, the connecting portion 43 is restricted from coming out of the attachment hole 25, and the conductive member 40 is held in the housing 20. The joint portion 64 extends in the up-down direction between the upper busbar portion 62 and the lower busbar portion 63 at one end in the left-right direction (the right end in the drawings).

As shown in FIGS. 1, 6, and 7, the joining portion includes a reinforcing portion 45 of a constant width with sides along the plate width facing left and right, and a weak portion 44 narrower than the reinforcing portion 45. The reinforcing portion 45 and the weak portion 44 each have plate surfaces facing front and rear, except its ends in the up-down direction (the below-described upper end root portion 68, lower end root portion 69, upper end reinforcing portion 74, and lower end reinforcing portion 75).

As shown in FIG. 6, the weak portion 44 is located forward of the reinforcing portion 45. The weak portion 44 is set to break first when a relatively large force acts on the conductive member 40 to pull the connecting portion 43 away from the fixing portion 30 side, such as when each coated electric wire 100 drawn out of the housing 20 is pulled upward, as described later. The upper end of the weak portion 44 is integrally connected to the rear end of the busbar body 65 of the lower busbar portion 63. The lower end of the weak portion 44 is integrally connected to the front end of the fastening body 46. In other words, the weak portion 44 is integrally connected to each of the connecting portion 43 and the fastening portion 42.

As shown in FIG. 6, the weak portion 44 includes the upper end root portion 68 that protrudes rearward from a position near one of the left and right sides at the rear end of the busbar body 65 of the lower busbar portion 63 and bends downward, the lower end root portion 69 that protrudes forward from a position near the other one of the left and right sides at the front end of the fastening body 46 and then bends upward, and a band plate portion 71 that extends in the left-right direction between the upper end root portion 68 and the lower end root portion 69. The upper end root portion 68 is integrally connected to the upper end of the band plate portion 71 that is an end on the one of the left and right sides. The lower end root portion 69 is integrally connected to the lower end of the band plate portion 71 that is an end on the other one of the left and right sides.

The weak portion 44 has a detoured S- or Z-shape in front view as a result of the band plate portion 71 extending in the left-right direction, compared to the case where the connecting portion 43 and the fastening portion 42 are connected linearly in the up-down direction. V-shaped notches 72 are formed on the left and right end surfaces (plate thickness surfaces) of the lower end root portion 69 of the weak portion 44. Each notch 72 is formed at the rear end of the lower end root portion 69 near the fastening body 46. When the foregoing relatively large force is applied, the weak portion 44 breaks from each notch 72 and a fracture surface 73 (see FIG. 11) in the left-right direction forms as an exposed surface between the notches 72 of the lower end root portion 69.

As shown in FIGS. 3 and 7, the reinforcing portion 45 includes the upper end reinforcing portion 74 that is integrally connected to the rear end of the busbar body 65 of the upper busbar portion 62, the lower end reinforcing portion 75 that is placed on the upper surface of the front end of the fastening body 46, and a cover portion 76 that extends downward from the upper end reinforcing portion 74 to the lower end reinforcing portion 75. The upper end reinforcing portion 74, the lower end reinforcing portion 75, and the cover portion 76 have a constant width in the left-right direction. The upper end reinforcing portion 74 protrudes rearward from an intermediate part in the left-right direction (a part excluding the left and right ends) of the rear end of the busbar body 65 and then bends downward. The lower end reinforcing portion 75 is curved downward and rearward from the cover portion 76, and has its rear end surface (plate thickness surface), which is a free end, facing rearward.

The cover portion 76 is disposed in the up-down direction. Embossed reinforcing side ribs 77 that bulge backward are formed at the left and right ends of the cover portion 76. Each reinforcing side rib 77 extends in the up-down direction on the cover portion 76. Each reinforcing side rib 77 is also formed continuously on the lower end reinforcing portion 75, and its lower end in the extending direction reaches the rear end surface of the lower end reinforcing portion 75 (see FIG. 9).

As shown in FIG. 7, a first locked portion 78 is formed in an intermediate part of the cover portion 76 in the left-right direction. The first locked portion 78 has a hole shape that is formed through the cover portion 76 in the plate thickness direction and extends in the up-down direction. As shown in FIG. 8, the reinforcing side ribs 77 are arranged on the left and right sides of the first locked portion 78. The first locked portion 78 is also formed continuously in the lower end reinforcing portion 75. As shown in FIG. 3, the first locked portion 78 has a first locked surface 79 extending in the left-right direction, in the lower end reinforcing portion 75. The first locked surface 79 of the first locked portion 78 faces forward, and can be locked by the first locking surface 53 (see FIG. 8) of the first locking portion 51 in a state of facing the first locking surface 53.

As shown in FIG. 7, second locked portions 81 are formed at the left and right ends of the lower end reinforcing portion 75. The reinforcing side ribs 77 are located on the inner side of the second locked portions 81 in the left-right direction. The second locked portions 81 include the upper surface, lower surface, and rear end surface of the lower end reinforcing portion 75, and are formed without performing special work on the left and right ends of the lower end reinforcing portion 75.

### (Functions of Connector 10)

When assembling the connector 10, first, the conductive member 40 is attached to the housing 20. Specifically, the connecting portion 43 is pressed into the attachment hole 25 from the rear of the housing 20 and held therein. Moreover, the tip portion 57 of each extending portion 55 is inserted into the corresponding receiving portion 28 from the rear of the housing 20 in a fitted state, as a result of which the extending portion 55 and the receiving portion 28 form a fitted part with an L-shaped cross-section at each of the left and right ends of the connector 10. Here, the extending portion 55 is merely inserted in the receiving portion 28 and is not locked in the receiving portion 28, as shown in FIG. 10. The exposed portion 41 of the conductive member 40 is exposed outside (behind) the housing 20, as shown in FIGS. 1 and 2.

After the conductive member 40 is attached to the housing 20, each terminal 90 is inserted into the corresponding cavity 23 from the front of the housing 20 and held therein. Each terminal 90 is in a state of being connected to the terminal portion of the coated electric wire 100 in advance. Each tab 66 of the connecting portion 43 of the conductive member 40 is connected to the corresponding terminal 90 inside the housing 20, as shown in FIG. 2.

In a state in which the connector 10 is mounted on a vehicle (not shown), the fastening portion 42 of the conductive member 40 is fixed (grounded) to the fixing portion 30 (body, ground portion) of the vehicle via a fixing member such as a bolt. The housing 20 with the conductive member 40 attached thereto is located at a position one step higher than the fastening portion 42 via the joining portions 44 and 45. When a relatively small force such as vibration (vibration with a low amplitude, hereafter also referred to as a small load) acts on the connector 10 during mounting of the connector 10 onto the vehicle or while the vehicle is running, the weak portion 44 may break (including fatigue failure). In Embodiment 1, however, since the reinforcing portion 45 is provided behind the weak portion 44, the small load acting on the joining portions 44 and 45 is distributed to not only the weak portion 44 but also the reinforcing portion 45, and thus is kept from concentrating at the weak portion 44. The weak portion 44 can therefore be prevented from breaking unintentionally. In particular, the reinforcing portion 45 is wider and has a larger area than the weak portion 44, and accordingly can resist the small load sufficiently.

As shown in FIG. 8, by inserting the first locking portion 51 into the first locked portion 78 and disposing the first locking surface 53 of the first locking portion 51 so as to be able to face and contact the first locked surface 79 of the first locked portion 78 from the front, the reinforcing portion 45 is restricted from being displaced forward relative to the fastening portion 42. Moreover, as shown in FIGS. 2 and 9, by sandwiching the second locked portions 81 between the fastening body 46 and the second locking portions 52 from above and below and disposing the second locking portions 52 so as to be able to face and contact the upper surfaces of the second locked portions 81, the reinforcing portion 45 is restricted from being displaced upward relative to the fastening portion 42. Furthermore, by disposing the second locking portions 52 so as to be able to face and contact the rear end surfaces of the second locked portions 81, the reinforcing portion 45 is restricted from being displaced backward relative to the fastening portion 42. Thus, when a small load acts on the joining portions 44 and 45 in the forward, rearward, or upward direction, the reinforcing portion 45 is restricted from being displaced (misaligned) relative to the fastening portion 42 and a good joining state of the fastening portion 42 and the reinforcing portion 45 can be maintained.

In addition, when a bending load acts on the connector 10 with the fastening portion 42 side as a fulcrum, the L-shaped cross-section fitted part of the extending portion 55 and the receiving portion 28 can resist the bending load (see FIGS. 1 and 10), so that the joining state of the fastening portion 42 and the reinforcing portion 45 can be maintained as above.

When dismantling the vehicle, each coated electric wire 100 drawn out of the housing 20 is hooked on a crane hook (not shown) or the like and pulled upward (including obliquely upward) away from the fixing portion 30 side. Then, a relatively large force (hereafter also referred to as a large load) acts on the housing 20 to pull it upward. As a result, first the lock between the reinforcing portion 45 and the fastening portion 42 is released and the reinforcing portion 45 is pulled away from the fastening portion 42. Then, as a result of the reinforcing structure provided by the reinforcing portion 45 being lost, the tip portion 57 of each extending portion 55 comes out of the corresponding receiving portion 28 and the weak portion 44 deforms so as to stretch in the direction in which each coated electric wire 100 is pulled. When each coated electric wire 100 is further pulled upward, the weak portion 44 stretches to the maximum extent and, starting with each notch 72, breaks from the fracture surface 73.

Consequently, of the conductive member 40, part of the lower end reinforcing portion 75 of the weak portion 44, the fastening portion 42, and the extending portions 55 remain on the fixing portion 30 side, as shown in FIG. 11. Meanwhile, of the conductive member 40, most of the weak portion 44 (excluding part of the lower end reinforcing portion 75), the connecting portion 43, and the reinforcing portion 45 are pulled away from the fixing portion 30 side together with the coated electric wires 100 and the housing 20. Since most of the weak portion 44, the reinforcing portion 45, etc. do not remain on the fixing portion 30 side, shredder dust from the harness parts etc. remaining in the vehicle can be reduced, which is advantageous from the viewpoint of environmental protection and economy.

As described above, according to Embodiment 1, when a relatively large force acts on the conductive member 40 during dismantlement of a vehicle having the connector 10 mounted thereon, the lock between the reinforcing portion 45 and the fastening portion 42 is released and the weak portion 44 is broken. As a result, the part of the conductive member 40 on the fastening portion 42 side remains on the fixing portion 30 and the part of the conductive member 40 on the connecting portion 43 side is pulled away from the fixing portion 30.

When a relatively small force acts on the conductive member 40 during mounting of the connector 10 onto the vehicle or while the vehicle is running, the force is distributed to not only the weak portion 44 but also the reinforcing portion 45, so that the weak portion 44 can be prevented from breaking unintentionally.

Moreover, according to Embodiment 1, the connecting portion 43 is located forward of and above the fastening portion 42, and the reinforcing portion 45 extends rearward and downward from the connecting portion 43 and has its lower end locked by the fastening portion 42, and includes the cover portion 76 covering the weak portion 44 from behind. Since the rear surface of the weak portion 44 is protected by the cover portion 76, the weak portion 44 can be prevented from being broken or damaged by an external force from behind (such as interference with a foreign object). In particular, since the reinforcing portion 45 extends rearward and downward from the connecting portion 43, the reinforcing portion 45 is also pulled away from the fixing portion 30 during dismantlement, with it being possible to reduce the amount of the conductive member 40 remaining on the fixing portion 30.

Moreover, the fastening portion 42 includes the first locking portion 51 that faces the lower end reinforcing portion 75 of the reinforcing portion 45 from front and the second locking portion 52 that faces the lower end reinforcing portion 75 of the reinforcing portion 45 from above. When such a force (the foregoing small load) that pulls the connecting portion 43 forward acts on the conductive member 40, the first locking portion 51 locks the first locked portion 78 of the reinforcing portion 45, so that the lock between the reinforcing portion 45 and the fastening portion 42 can be maintained. When such a force (the foregoing small load) that pulls the connecting portion 43 upward acts on the conductive member 40, the second locking portion 52 locks the second locked portion 81 of the reinforcing portion 45, so that the lock between the reinforcing portion 45 and the fastening portion 42 can be maintained. Thus, the lock between the reinforcing portion 45 and the fastening portion 42 can be maintained regardless of whether a force acts on the conductive member 40 in the forward or upward direction.

Moreover, in the structure of the conductive member 40, the weak portion 44 extends rearward and downward from the lower busbar portion 63, and the reinforcing portion 45 extends rearward and downward from the upper busbar portion 62. Therefore, the weak portion 44 and the reinforcing portion 45 can be produced from metal plates with relatively good yield.

Moreover, the weak portion 44 is shaped to extend from the connecting portion 43 side to the fastening portion 42 side in a detour so as to be longer than the reinforcing portion 45. Accordingly, when a relatively large force acts on the conductive member 40 during dismantlement of the vehicle having the connector 10 mounted thereon, first the lock between the reinforcing portion 45 and the fastening portion 42 side is released and then the weak portion 44 is destroyed. It is thus possible to appropriately achieve each of the state in which the lock between the reinforcing portion 45 and the fastening portion 42 side is released and the state in which the weak portion 44 is destroyed. In addition, the load (stress) acting on the conductive member 40 can be distributed in the length direction of the weak portion 44 because the weak portion 44 extends in a detour. Hence, the weak portion 44 can be more reliably prevented from breaking unintentionally.

Moreover, the conductive member 40 includes the extending portion 55 extending from the fastening portion 42 toward the connecting portion 43, the extending portion 55 is located away from the joining portions 44 and 45, and the housing 20 includes the receiving portion 28 in which the tip portion 57 of the extending portion 55 is fitted. Therefore, when a bending load acts on the joining portions 44 and 45, the fitted part of the extending portion 55 and the receiving portion 28 can resist the bending load. In particular, since the extending portion 55 is located away from the joining portions 44 and 45, the bending load transmitted to the locked part of the reinforcing portion 45 and the fastening portion 42 side can be reduced and the lock between the reinforcing portion 45 and the fastening portion 42 side can be maintained. In addition, since the extending portion 55 does not have a structure of being locked in the housing 20, the extending portion 55 can easily come out of the housing 20 during dismantlement.

Moreover, the rear surface of the housing 20 is the drawing surface 26 from which the conductive member 40 is drawn out, and the receiving portion 28 is a lightening hole that opens on the drawing surface 26. The receiving portion 28 thus has both the function of receiving the extending portion 55 and the function of a lightening hole (such as preventing shrinkage of the housing 20 and reducing the weight). Hence, the formation of the receiving portion 28 does not complicate the structure of the housing 20.

### Other Embodiments of the Present Disclosure

The foregoing Embodiment 1 disclosed herein is illustrative and not restrictive in all respects.

In Embodiment 1, the conductive member 40 is attached to the housing 20 by being inserted into the attachment hole 25. In another embodiment, the conductive member may be attached to the housing by insert molding.

In Embodiment 1, the reinforcing portion 45 is shaped to extend from the connecting portion 43 side to the fastening portion 42 side and be locked on the fastening portion side. In another embodiment, the reinforcing portion may be shaped to extend from the fastening portion side to the connecting portion side and be locked on the connecting portion side. Alternatively, the reinforcing portion may be composed of a part extending from the connecting portion side to the fastening portion side and a part extending from the fastening portion side to the connecting portion side, and the two parts may be locked with each other in an intermediate part of the joining portion in the up-down direction.

In Embodiment 1, the housing 20 in which the terminals 90 are contained is the same as the housing 20 to which the conductive member 40 is attached. Alternatively, the housing in which the terminals are contained may be different from the housing to which the conductive member is attached, and may be fitted with the housing in which the conductive member is contained.

In Embodiment 1, the reinforcing portion 45 is disposed so as to cover the weak portion 44 from behind. In another embodiment, the reinforcing portion may be disposed so as to cover the weak portion from the front. The reinforcing portion may cover only part of the weak portion. Alternatively, the reinforcing portion may be shifted in position from the weak portion without covering the weak portion.

In Embodiment 1, the reinforcing portion 45 is locked on the fastening portion 42 side by both the first locking portion 51 and the second locking portion 52. In another embodiment, the reinforcing portion may be locked on the fastening portion side by one of the first locking portion and the second locking portion. The number and arrangement of first locking portions and the number and arrangement of second locking portions are not limited.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a housing; and
a conductive member made of metal and attached to the housing,
wherein the conductive member includes:
a fastening portion located outside the housing and fastened to a fixing portion;
a connecting portion located inside the housing and connected to a terminal; and
a joining portion located between the connecting portion and the fastening portion, outside the housing, and
the joining portion includes:
a weak portion integrally joined to each of the connecting portion and the fastening portion and breakable; and
a reinforcing portion extending at least from one side to another side out of a side where the connecting portion is located and a side where the fastening portion is located, and locked on the other side.

2. The connector according to claim 1, wherein the connecting portion is located forward of and above the fastening portion, and
the reinforcing portion extends rearward and downward from the connecting portion and has a lower end locked by the fastening portion, and includes a cover portion covering the weak portion from behind.

3. The connector according to claim 2, wherein the fastening portion includes a first locking portion that faces the reinforcing portion from front and a second locking portion that faces the reinforcing portion from above.

4. The connector according to claim 2, wherein the connecting portion includes:
an upper busbar portion;
a lower busbar portion located below the upper busbar portion; and
a joint portion joining the upper busbar portion and the lower busbar portion at one end,
the upper busbar portion and the lower busbar portion each include a plurality of tabs protruding forward,
the weak portion extends rearward and downward from the lower busbar portion, and
the reinforcing portion extends rearward and downward from the upper busbar portion.

5. The connector according to claim 1, wherein the reinforcing portion is shaped to extend from the one side to the other side, and
the weak portion is shaped to extend from the one side to the other side in a detour so as to be longer than the reinforcing portion.

6. The connector according to claim 1, wherein the conductive member includes an extending portion extending from the fastening portion toward the connecting portion,
the extending portion is located away from the joining portion, and
the housing includes a receiving portion in which a tip portion of the extending portion in an extending direction is fitted.

7. The connector according to claim 6, wherein a rear surface of the housing is a drawing surface from which the conductive member is drawn out, and
the receiving portion is a lightening hole that opens on the drawing surface.
